(19) United States
(12) Patent Application Publication
(10) Pub. No.: US 2026/0311935 A1
(43) Pub. Date: Oct. 8, 2026

(54) Non-polar Photo-dependent Variable Capacitor

(71) Applicant: Swaresh Borse, Allen, TX (US)

(72) Inventor: Swaresh Borse, Allen, TX (US)

(73) Assignee: Swaresh Borse, Allen, TX (US)

(21) Appl. No.: 19/170,061

(22) Filed: Apr. 4, 2025

(51) Int. Cl. H01G 4/40

(52) U.S. Cl. CPC H01G 4/40

(57) ABSTRACT

The present invention is an electronic circuit comprised of photodiodes and ceramic disc capacitor electrically connected in such a way that it forms a variable capacitor dependent on intensity of incident light. Said invention can be implemented in all applications that deal with photons and optical physics that require electronic circuitry such as fiber optics. Said invention provides more advantages over current conventionally used variable capacitors such as a varactor diode or a mechanically controlled variable capacitor. When a varactor diode is used as a capacitor, it requires an external reverse-biased voltage to control the capacitance. Said invention uses external source of light to control said capacitance and is independent of the requirement to supply an external voltage for capacitance control. A varactor diode can only be used in reverse-biased mode. Said invention in non-polar which provides flexibility in connecting it in any direction in a given circuit.

### CROSS REFERENCE TO RELATED APPLICATIONS

This application does not provide reference to any prior applications.

### BACKGROUND OF THE INVENTION

### 1. Field of Invention

Capacitors, in general, are a vital part of electronic circuitry and they play a crucial role in AC as well as DC circuits. Their ability to store electric charge is the fundamental principle of their operation. Present invention relates to variable capacitors that depend on light for their operation. Variable capacitors have multiple applications in electronic circuits ranging from tuning circuits, filter circuits, oscillator circuits, etc.

### 2. Description of Related Art

The basic construction of a capacitor includes two conducting plates separated by an insulator. Any variation in this assembly has an impact on the value of capacitance. This is the working principle of a variable capacitor. A photodiode is an electronic component that conducts electric current which can be controlled by the intensity of light incident on the P-N junction of said photodiode. Just like any diode, photodiodes too have a parasitic capacitance. Said invention is created by combining the working principles of a variable capacitor and operation mechanism of photodiodes.

Said invention uses light to change the value of capacitance. The intensity of light incident on said invention controls the value of capacitance. Said invention is non-polar in nature making its implementation flexible in electronic circuits.

### SUMMARY OF THE INVENTION

The present invention is a light-dependent capacitor that provides a wide range of capacitance values. The stronger the intensity of light incident on said invention, the more capacitance is provided by said invention. Said invention's working principle is primarily based on photodiode operation. Any diode connected in a reverse biased configuration can function as a capacitor. A photodiode when connected in reverse biased configuration can be made to function as a variable capacitor whose value changes with changes in incident light intensity. Said invention is implemented by connecting two photodiodes in series with each other in a way that either they form a cathode-to-cathode connection or an anode-to-anode connection. This series connection is then connected in parallel with a ceramic disc capacitor. Said ceramic disc capacitor is required for practical implementation of said invention.

Said invention can be implemented in radio frequency technology where tuning circuits, filters and oscillators are common components and capacitors are vital part of such elements. Other applications may include charging and discharging implementations in a circuit, lux meters, audio-visual circuits, etc.

### BRIEF DESCRIPTION OF INVENTION DRAWINGS

FIG. 1. Functioning of variable capacitor

FIG. 2 Working principle of photodiode

FIG. 3. Semiconductor P-N junction diode in reverse biased configuration

FIG. 4. Construction of said invention

FIG. 5. Common anode circuit diagram

FIG. 6. Common anode equivalent circuit diagram

FIG. 7. Common cathode circuit diagram

FIG. 8. Common cathode equivalent circuit diagram

FIG. 9. Circuit symbol

FIG. 10. Light saturation point

FIG. 11. Light saturation point equivalent circuit diagram

FIG. 12. Preventing light saturation point circuit diagram

FIG. 13. Said invention operation graph

### DETAILED DESCRIPTION OF INVENTION

The present invention uses a combination of working principles of a variable capacitor and a photodiode. Said invention is implemented by changing the distance between its conductive plates and changing a photodiode's depletion region size due to variation in light intensity.

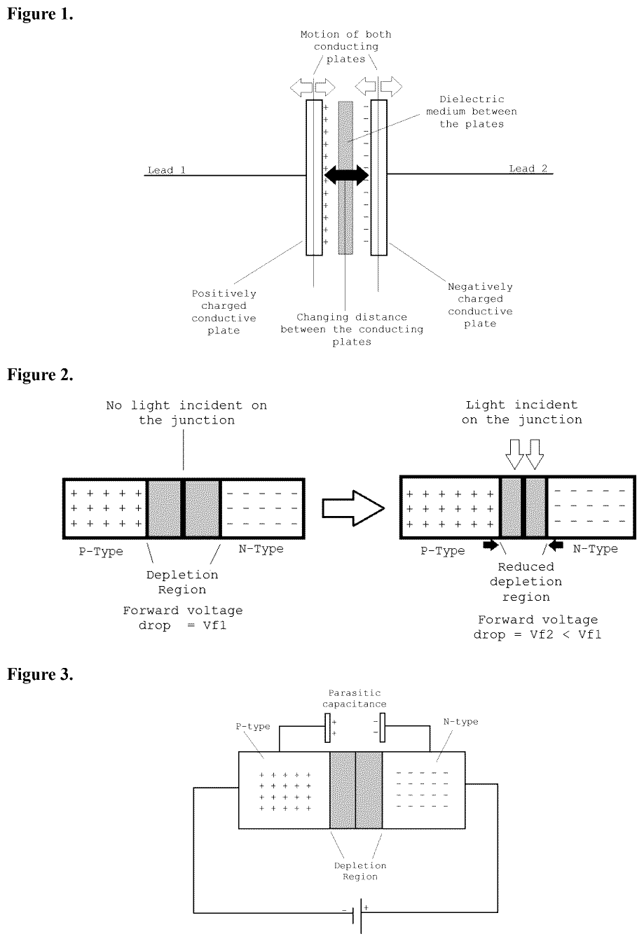

A simple capacitor consists of two conductive plates separated by a dielectric medium. While operating any capacitor, one of the two said conductive plates is positively charged and the other is negatively charged. Upon changing the distance between these two plates the capacitance value of said capacitor changes. FIG. 1 in invention drawings illustrates this phenomenon. There are other factors that impact the value of capacitor such as surface area overlap of said conductive plates or dielectric constant of the insulator used. However, said invention is based on changes in capacitance due to change in distance between the two conductive plates.

Like any semiconductor diode, the P-N junction in photodiodes forms a depletion region. Said depletion region is exposed to ambient light in a photodiode. Said depletion region creates a forward voltage drop in diodes. The size of said depletion region and its forward voltage drop at any given instance in time depends on intensity of light incident on the junction. FIG. 2 in invention drawings show the change in size of the depletion region. The more light falling on said P-N junction, the lesser the size of the depletion region gets and said forward voltage drop reduces.

Any semiconductor P-N junction diode can function as a capacitor when connected in a revers biased configuration. Said capacitance in said P-N junction diodes is result of said depletion region existing between a P-type semiconductor region and an N-Type semiconductor region. Said depletion region acts as a dielectric separating two conductive plates (P-Type semiconductor region and N-type semiconductor region). FIG. 3 illustrates a reverse biased semiconductor P-N junction and parasitic capacitance. When light is incident on said P-N junction of a photodiode, the depletion region reduces which can be understood as reducing distance between said two conductive plates (P-type and N-type regions). This in turn increases value of said parasitic capacitance.

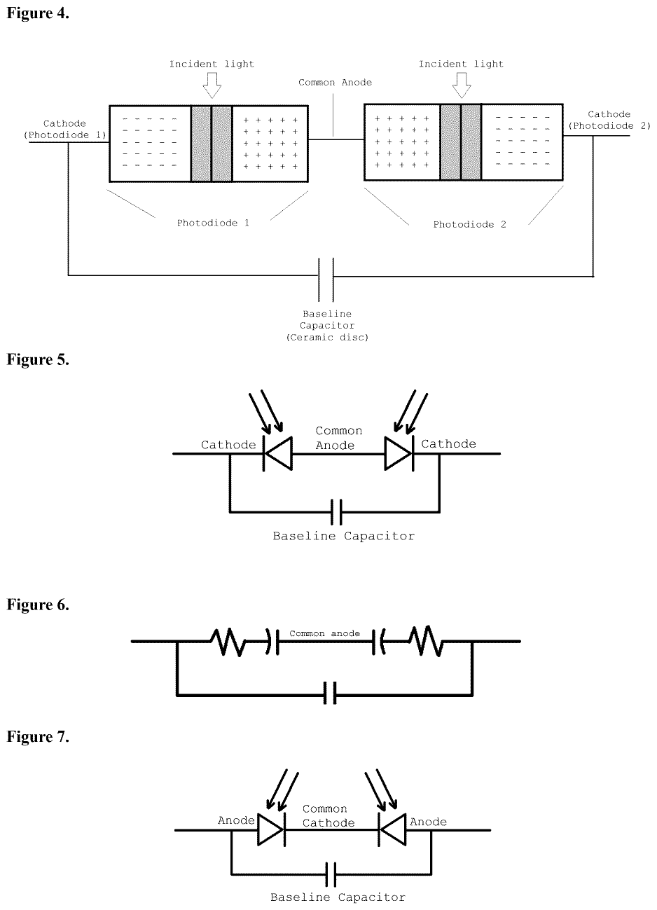

Said invention is constructed by connecting two photodiodes in series with each other and parallel to a ceramic disc capacitor. Said photodiodes can be connected in a common anode or common cathode configuration. FIG. 4 shows such a construction of said invention in a common anode configuration. Utilizing two photodiodes in series with a common anode or common cathode configuration eliminates the requirement to operate said photodiode in reverse biased condition only. This makes said invention non-polar in nature. A ceramic disc capacitor connected in parallel helps implement said invention in practical applications.

The effective capacitance of said invention constructed in the above said way at a given incident light intensity is given by the following equation:

$${C}_{T} ( i ) = [ [ {C}_{p 1} ( i ) ⋆ {C}_{p 2} ( i ) ] / [ {C}_{p 1} ( i ) + {C}_{p 2} ( i ) ] ] + {C}_{b 1} \qquad ( 1 )$$

Where,
i: Intensity of incident light
C_{T}: Effective capacitance of said invention
Cₚ₁: Parasitic capacitance of photodiode 1 as shown in FIG. 4
Cₚ₂: Parasitic capacitance of photodiode 2 as shown in FIG. 4
C_{bl}: Fixed ceramic disc capacitor shown as baseline capacitor in FIG. 4

When light is incident on said invention, parasitic capacitance of said photodiodes changes according to the intensity changes of said incident light, there by changing the effective capacitance (C_{T} in equation (1) above) of said invention.

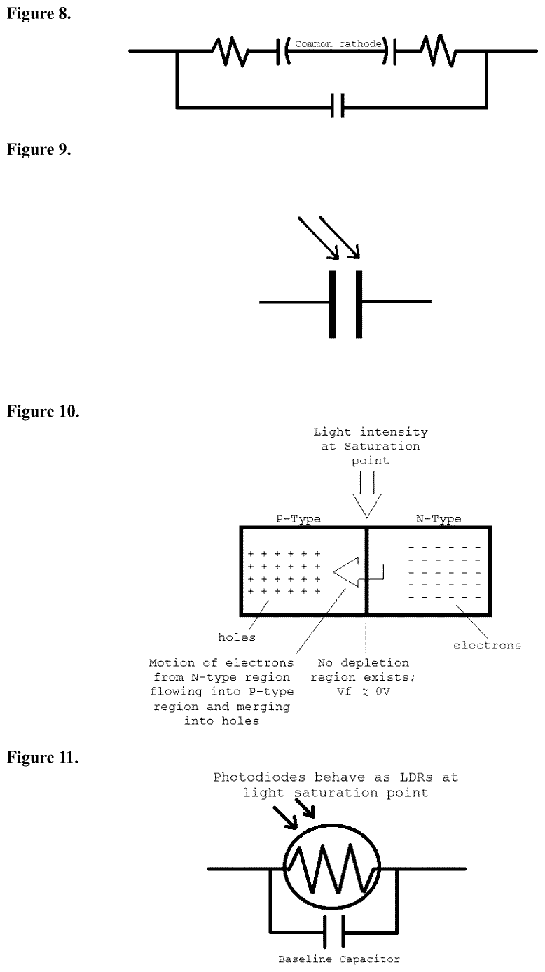

Said invention can be constructed in common anode configuration as illustrated in FIG. 5 of invention drawings or common cathode configuration as illustrated in FIG. 7 of invention drawings. Said common anode configuration and said common cathode configuration, the equivalent circuit diagrams of which, are illustrated in FIG. 6 and FIG. 8 of invention drawings respectively. FIG. 9 shows the circuit symbol of said invention that can be used in circuit diagrams for circuits using said invention.

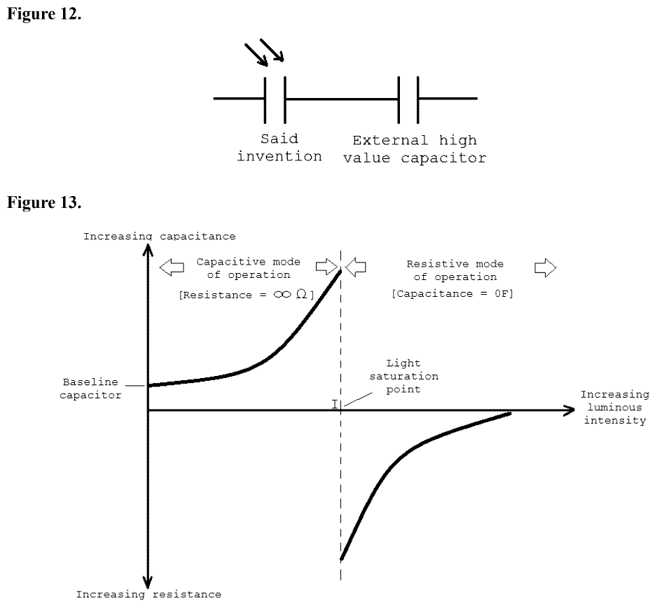

As intensity of light incident on said invention increases, said depletion regions of photodiodes, used in building said invention, decreases. As intensity of said incident light further continues to increase, said depletion regions of both said photodiodes continues to reduce. A point comes where said depletion region becomes so thin that it ceases to exist and hence no said parasitic capacitance of said photodiodes exists. Said invention operates in a variable resistance mode as shown in FIG. 11. This intensity of light incident upon said invention is termed as LSP (Light Saturation Point) beyond which further increase in intensity of said incident light makes said invention operate in resistive mode. This phenomenon is illustrated in FIG. 10. In practical circuit implementations, to prevent driving said invention in resistive mode of operation, an external high value capacitor can be connected in series with said invention as shown in FIG. 12.

Let's say said intensity of incident light is ‘I’ at said LSP. Equation (1) above becomes:

$${C}_{T} ( I ) = 0 \qquad ( 2 )$$

Where,

$$i >= I$$

FIG. 13 illustrates the functioning of said invention in a graphical representation. It shows two said modes of operation—Capacitive mode on the left side of said LSP where said invention behaves as a variable capacitor and Resistive mode on right side of said LSP where said invention behaves as a light dependent resistor. While operating in capacitive mode the resistance of said invention is ∞Ω and while operating in resistive mode the capacitance of said invention is 0 F.

The baseline capacitance point is the capacitance value of said fixed capacitor (baseline capacitor) which is connected in parallel to said series connection of photodiodes. Even with 0 incident light, said invention will operate at a minimum of said baseline capacitance value.

The invention claimed is:

1. A circuit comprising:
two photodiodes wherein anode terminal of one of said photodiodes is connected to anode terminal of second one of said photodiodes; and
one fixed capacitor with two terminals wherein cathode terminal of one of said photodiodes is connected to one of said terminals of said fixed capacitor and cathode terminal of second one of said photodiodes is connected to said second terminal of said fixed capacitor.

2. A circuit comprising:
two photodiodes wherein cathode terminal of one of said photodiodes is connected to cathode terminal of second one of said photodiodes; and
one fixed capacitor with two terminals wherein anode terminal of one of said photodiodes is connected to one of said terminals of said fixed capacitor and anode terminal of second one of said photodiodes is connected to said second terminal of said fixed capacitor.
